(19) United States
(12) Patent Application Publication
(10) Pub. No.: US 2011/0150755 A1
(43) Pub. Date: Jun. 23, 2011

(54) Method and Apparatus for Hydrating Lime

(75) Inventor: Charles R. Euston, Hamburg, PA (US)

(73) Assignee: FLSMIDTH A/S, Valby (DK)

(21) Appl. No.: 12/643,422

(22) Filed: Dec. 21, 2009

(51) Int. Cl. C01F 11/02; B01J 8/18

(52) U.S. Cl. 423/640; 422/140

(57) ABSTRACT

In a process for the hydration of a material containing CaO, the material is contacted with water near the bottom of a vertical gas suspension column to thereby at least partially hydrate the material. The material is thereafter transported upward through and out of the vertical gas suspension column in an entraining gas that enters the vertical gas suspension column near its bottom.

### FIELD OF THE INVENTION

This invention relates to hydrating a particulate or pulverulent material containing CaO in a gas suspension apparatus and process. In one aspect, this invention relates to a process for hydrating lime that is both energy efficient and overcomes many of the disadvantages of prior art hydrating lime processes.

### BACKGROUND OF THE INVENTION

Hydrated lime products are used in flue gas treatment (for the control of SO₂ and S0₃ emissions), chemical manufacturing, water and waste water treatment, acid neutralization, construction and other environmental applications.

Present art for so-called “dry” hydrating quicklime consists almost entirely of horizontal troughs that are agitated by paddles mounted on one or two horizontal shafts. The paddles are angled to convey the material towards the discharge end of the trough. Multiple troughs may be used to break the hydrator into a prehydrator, hydrator and finishing section.

Present hydrators require a tight balance of proper mixing and water addition. Improper mixing and/or water addition can lead to “water-burning” which leads to the production of “gritty hydrate”, produced by heating moist particles. Such a condition is believed to occur for two reasons. First, particles of highly reactive lime can hydrate so rapidly that water does not penetrate sufficiently far into the particle to cause it to split. As a result, the particle (which may be up to 3 mm in diameter) may have a core of unhydrated quicklime surrounded by a hard shell of baked putty of hydrated lime. Secondly, inadequate agitation and/or uneven addition of water can lead to localized hot spots where particles of hydrated lime can agglomerate and “bake” together.

In addition, the process of starting up and shutting down dry hydrators, such as because of an upset condition or for other reasons, can be laborious, in part because of the comparatively long residence time required by such hydrators resulting in extensive inventory if desired production rates are to be achieved. Typically such hydrators require approximately twenty minutes material residence time and require between about 30 to 40 minutes to start up, during which time “offspec” product is likely.

### SUMMARY OF THE INVENTION

The present invention offers several advantages over conventional dry hydrators which will become apparent.

The present invention consists of a vertical gas suspension vessel having a cylindrical upper part and a conical (i.e., conical or frusto-conical) lower part, with the conical lower part comprising approximately one fifth to one quarter of the total height of the vessel. In one embodiment, water and suitably sized quicklime are separately introduced in the general vicinity of the bottom of the upper part of the vessel, with air being introduced at the bottom of the conical section. The quicklime is entrained upwards in the air stream. Velocities in the vessel are such that all the material does not immediately leave the vessel but instead some of the heavier material falls back towards the conical lower part where it is reentrained in the air stream. This action quickly sets up a very dense, high agitated material zone in the conical section of the vessel.

Water may also be introduced into this very dense, highly agitated material zone where some water reacts with the quicklime and some is evaporated—thus cooling the process, which is exothermic in nature. The present invention offers mixing several orders of magnitude larger than present art. Particle to particle abrasion in this highly turbulent region along with the ablation of the outer layers of the quickline as a result of hydration, reduces the size of the lime particles thus ensuring new quicklime surfaces are available to hydrate. The nature of gas suspension systems offer high mass and heat transfer rates resulting in a uniform temperature profile throughout the reaction vessel. These properties of the present invention greatly reduce the two mechanisms of “water-burning” discussed above. Furthermore, the material residence and shut down time in the hydrator of the present invention (10-15 seconds average material residence time and from being fully operational to having no product in about 30 seconds) lends the hydrator to be more responsive to operational start-up and shut down requirements. Because of these advantages, the present invention lends itself to successfully hydrating a highly reactive lime.

Various embodiments of the invention are further described in the Figures in which like numerals are employed to designate like parts.

### BRIEF DESCRIPTION OF THE DRAWINGS

FIG. 1 depicts one embodiment of the present invention in which a vertical suspension hydration column is utilized with a downstream cyclone and baghouse.

FIG. 2 depicts the vertical suspension hydration column utilized in the present invention with a downstream baghouse.

FIG. 3 depicts another embodiment of the invention showing the direction of product from vertical suspension hydration column directly to a another industrial process.

### DETAILED DESCRIPTION OF THE INVENTION

It should also be understood that the following description is intended to completely describe the invention and to explain the best mode of practicing the invention known to the inventors but is not intended to be limiting in interpretation of the scope of the claims. The drawing is not necessarily to scale, emphasis instead being placed upon illustrating the principles of the invention.

Any conventional process can prepare the lime (CaO) used in the practice of this invention.

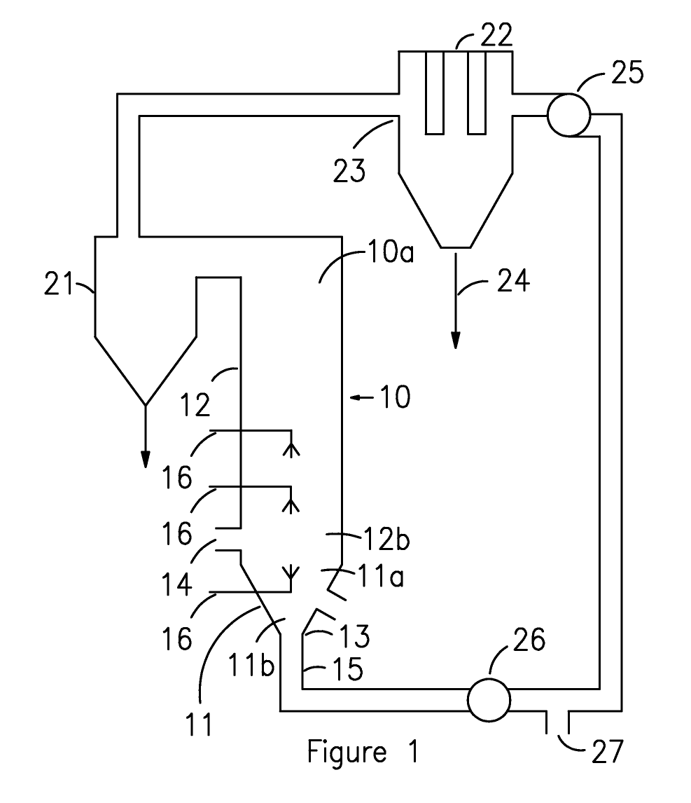

With reference to FIG. 1, there is a vertical gas suspension mixing column 10 having lower conical portion 11, which typically takes up about 20% to 25% of the vertical length of gas suspension column 10, and upper cylindrical portion 12. The air inlet end 13 of column 10 is connected to a source of typically ambient air.

The gas suspension column 10 typically will have a more uniform and lower temperature profile that prior art dry hydration devices, which can reach internal temperatures of approximately 200° C. Column 10 will have less of a tendency to develop isolated hot spots, and therefore is adaptable to being constructed of a wide variety of materials including steel, stainless steel, aluminum, and plastics such as PVC. The column is typically insulated to minimize heat loss through its sidewall.

Prior to entering gas suspension column 10, air will travel through a high air velocity throat area 15. The throat inlet 15 will be constricted to provide for a higher air velocity. Typically the area 15 will have an internal diameter to allow for an air velocity through the throat and the air inlet 13 of about 25 to about 30 m/s air velocity. This ensures there is adequate air velocity to pick up any larger feed that can not be initially entrained within the upper cylindrical portion 12 of the mixing column prevent such feed from falling down into the throat area. Such feed will be initially maintained in the lower conical area 11 where hydration and ablation of the outer surfaces of the larger feed will initially occur, in addition to there being mechanical size reduction of the feed in the lower conical area 11. Lower conical area 11 has, other than at its very upper most region 11a, a smaller internal diameter than upper cylindrical portion 12. The diameter of lower conical area 11 becomes increasingly smaller approaching the inlet/throat area. Because of a restricted flow area when compared to the flow area of upper cylindrical portion 12, lower conical area 11 will in general have a significantly higher air velocity than present in upper cylindrical portion 12, with such velocity being from about 25-30 m/s at the bottom 11b of the conical portion and gradually decreasing to about 1.5 to about 3 m/s as the internal diameter of the conical portion gradually increases toward the top 11a of the conical section 11.

Upper cylindrical portion 12 is designed to have a larger internal diameter to allow for an air velocity of about 1.5 to about 3 m/s to have the finer hydrate carried up and out of the gas suspension column 10.

Lime (CaO), typically at ambient temperature, and liquid water, from ambient to about 80° C., are injected, via inlet ports 14 and 16, respectively, downstream from air inlet end 13. The preferred location of inlet port 14 is in the general area where portions 11 and 12 adjoin which therefore will be in a lower portion 12b of the gas suspension column. Therefore, in such a preferred embodiment the lime is inserted above the high velocity conical portion 11 where it is picked up by the air stream. Smaller hydrated particles will be carried through the upper cylindrical portion 12 and out of the gas suspension column 10. Larger particles will fall into the high velocity conical area 11 for further treating.

Water is added via water inlets 16 which can be fine misting water nozzles. There are at least one nozzle 16, and preferably a plurality of nozzles, with at least one nozzle positioned in the high velocity conical area 11 to direct the water spray up towards the area where lime initially enters the mixing column 10 via feed inlet 14. At least one (and preferably two or more) nozzles are positioned above the feed entry point and direct the water spray down toward the material entering via the feed inlet. Such nozzle or nozzles create a cylinder of fine misted water that will serve to cool the supplied raw meal and will react with CaO to result in the simultaneous formation of Ca(OH)₍₂₎. In general, hotter water will promote a more complete hydration of the material. The amount of water inserted will typically range from about 25% to about 80% of the amount of lime material injected, on a weight basis.

The velocity of air through column 10 is such to entrain fully hydrated Ca(OH)₍₂₎ fines therein. Larger particles, which may only have the surface areas hydrated, will fall down through the column into high turbulence area 11, in which they will undergo size reduction and further hydration.

Typically column 10 is of a length so that the residence time of the fully hydrated Ca(OH)₍₂₎ fines that basically pass directly through the column will range from about one half to about five seconds.

If the end user desires finer grades of a hydrate product, the fines may pass from top area 16a of the gas suspension column to optional separator cyclone 21, after which any coarser materials may be reinserted into inlet port 14. Fully hydrated fines entrained in gas will be directed to baghouse 22, which may be a jet pulse baghouse. The dust-laden gas enters the baghouse through inlet 23 and is filtered through the bag. During cleaning, hydrated product will exit via outlet 24 into a hopper (not shown) located below the baghouse.

Exhaust gases/steam drawn out of the baghouse by induced draft fan 25 can be recirculated to the forced draft fan 26 and thereafter into the gas suspension column. By recirculating the exhaust gases/steam, the CO2 in the air is lessened. This in turn will lessen the possibility of any air-carbonation of the hydrate and result in a lower probability for scaling inside of delivery lines/nozzles. Gas outlet 23 can be used to bleed air from the system.

In some cases it may be advantageous to recirculate some of the hydrated product to the gas suspension column 10. This may possibly be done by splitting off some of the output from baghouse 22. This can serve, for example, to reduce the temperature of the lime feed material into column 10, thus reducing the temperature within column 10, thereby reducing also the amount of water required to keep the temperature of the material containing CaO within a temperature range where Ca(OH₍₂₎) is stable. The recirculation of hydrated product to the column will make it possible to adjust the temperature in the suspension column 10 independently of the injected amount of water. This will also reduce the tendency of moist material sticking to and forming cakings on the column wall, and can promote a more complete hydration of the lime feed.

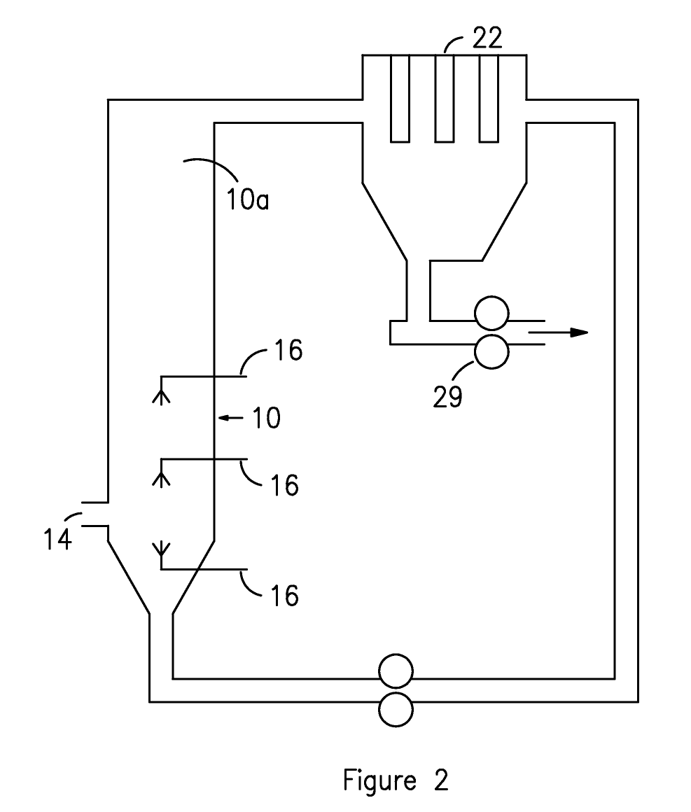

FIG. 2 illustrates another embodiment of the invention in which an intermediate cyclone separator is not utilized. The hydrated product can be sent to storage as described previously. Alternatively the product can be directed by forced blower 29 to the next stage, such as for direct use in a SO₂ or SO₃ removal system in an industrial plant, with no hopper, bin, or silo in between. This will keep the material “fluidized” and easier to handle.

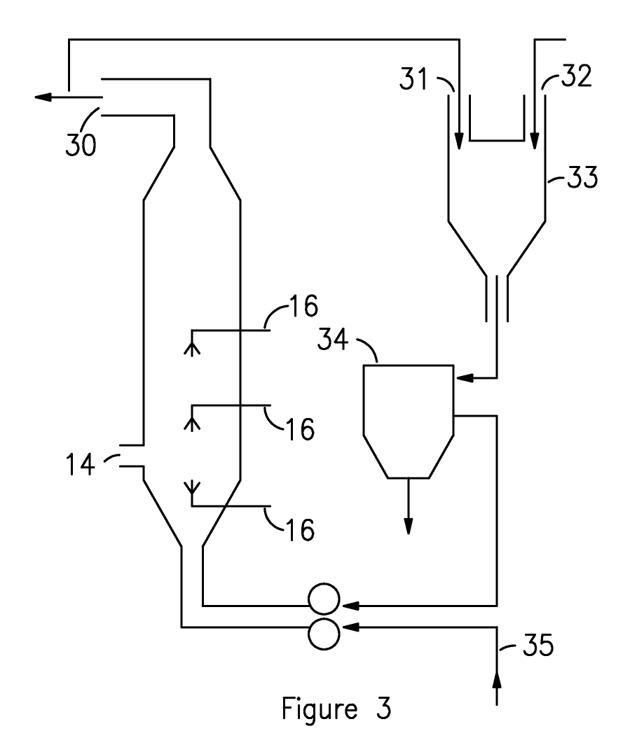

In the optional embodiment of FIG. 3 the hydrate product is delivered directly to a SOx removal system (not shown) via outlet 30 in a streamlined system in which at least one, or as depicted both, collection vessels, i.e. cyclone or baghouse, is eliminated. In a further optional embodiment, a small (i.e. less than about 5% by weight) slip stream of hydrate product is diverted from outlet line 30 and is inserted via inlet 31 with incoming ambient air (via inlet 32) into a CO₂ scrubber 33 in order to remove CO₂ from the air and form an air-carbonated product (hydrate/CaCO₃) which is then collected in a baghouse 34 and sent to product. The CO₂ free air tends to prevent material scaling in the conveying systems and can be used by itself or in conjunction with another source of gas (such as N₂) which enters the system via conveying line 35.

The hydration process of the present invention is advantageously performed at atmospheric pressure for most grades of lime. The process can be operated above atmospheric pressure is desired, which may be advantageous for hydrating dolomitic lime, for example.

Since this reaction is highly exothermic, heat is released and raises the shell temperature of the vessel. This excess heat can be optionally used to heat the water used for the reaction, either by running the water lines on the outside of the shell, or by having them run along the inside of the shell of the gas suspension vessel.

The residence time of the gas in the gas suspension column hydration unit of the present invention will be in the range of from about ½ to about 5 seconds, and most typically between about ½ and about 3 seconds. The solid material may stay in the gas column for longer times depending upon there size and reactivity. The solids will stay in the reactor until there is significant size reduction due primarily to ablation that the material will be taken from the reactor by the air stream. Typically, the residence time of the material in the present gas suspension reactor will be much less than the residence time in the prior art hydration units discussed above, thus improving the energy efficiency of the process.

The present method will result in hydration rate greater than 95% and at times greater than 99%.

Although this invention has been described in detail by reference to the drawings, this detail is for illustration only, and it is not to be construed as a limitation upon the invention as described in the appended claims.

What is claimed is:

1. A process for the hydration of a material containing CaO comprising:
(i) inserting material containing CaO into a vertical gas suspension column,
(i) contacting the material in the vertical gas suspension column with water in the vicinity where the material enters the vertical gas suspension column to thereby at least partially hydrate the material;
(ii) transporting the material upward through and out of the vertical gas suspension column in an entraining gas, said gas entering the vertical gas suspension column near its bottom and below where the material enters the column.

2. The process of claim 1 further comprising the step of separating at least some of the material from the entraining gas after said entraining gas exits the vertical gas suspension column.

3. The process of claim 2 wherein the separating step takes place in one or both of a seperator cyclone or a baghouse.

4. The process of claim 3 wherein the baghouse is a jet pulse baghouse.

5. The process of claim 1 further comprising transporting the material from the gas suspension column to a SOx removal system in an industrial plant.

6. The process of claim 1 further comprising splitting off a small portion of the material after it exits the gas suspension column and utilizing said material to remove CO₂ from entraining gas prior to said gas entering the vertical gas suspension column.

7. The process of claim 1 wherein the water with which the material is contacted is at a temperature ranging from ambient to about 80° C.

8. An apparatus for hydrating material containing CaO, said apparatus comprising
(i) a vertical gas suspension column having a cylindrical upper section having a top area and a bottom area and a conical lower section having a top area and a bottom area, said column adapted to have gas move therethroughin an upward direction,
(ii) an inlet for material containing CaO located near the bottom area of the upper section,
(iii) at least one inlet for water located near the bottom area of the cylindrical upper section,
(iv) an inlet for gas located near the bottom area of the conical lower section, and
(v) an outlet for gas and entrained hydrated material located near the top area of the upper section.

9. The apparatus of claim 8 wherein there are at least two inlets for water, with one inlet located above the gas inlet and directing water downwardly, and one inlet located below the gas inlet and directing water upwardly.

10. The apparatus of claim 8 wherein the conical section is sized so that gas moving therethrough will have a velocity of about 25 about 30 m/sec in the bottom area of the conical section, with said velocity decreasing as the gas moves upwardly through said conical section until it reaches a velocity of from about 1.5 to about 3.0 m/sec in the upper area of the conical section.

11. The apparatus of claim 8 wherein the cylindrical section is sized so that gas moving therethrough will have a velocity of about 1.5 about 3.0 m/sec throughout said cylindrical upper section.
